(19) United States
(12) Patent Application Publication
(10) Pub. No.: US 2009/0115879 A1
(43) Pub. Date: May 7, 2009

(54) Information management method and digital camera

(76) Inventors: Hideki Nagata, Hachioji-shi (JP); Hiroyuki Minakata, Hachioji-shi (JP); Takayuki Ide, Fussa-shi (JP); Atsushi Kohashi, Akiruno-shi (JP); Minoru Omaki, Kunitachi-shi (JP)

Correspondence Address: Kenyon & Kenyon, Suite 700, 1500 K Street, N.W., Washington, DC, 20005-1257, US

(21) Appl. No.: 11/903,901

(22) Filed: Sep. 24, 2007

(30) Foreign Application Priority Data
Sep. 28, 2006 (JP) 2006-264754

(51) Int. Cl. H04N 5/222; G06K 7/00

(52) U.S. Cl. 348/333.01; 235/380; 348/E05.022

(57) ABSTRACT

An information management method and digital camera which can reduce the burden on a user in terms of information management, while ensuring security, are provided. The invention provides a digital camera including an image-acquisition unit for acquiring image information; an ID reading unit for reading identification information of a wireless IC tag built into personal belongings that an image-acquiring person carries; a recording unit for associating and recording the read identification information and image information; a display unit for displaying the image information; and a control unit. At the time of a display request for the image information, the control unit displays the image information on the display unit when the identification information read by the ID reading unit matches the identification information associated with the image information which is the subject of the display request.

### BACKGROUND OF THE INVENTION

1. Field of the Invention

The present invention relates to an information management method and a digital camera which are capable of information management in which security and convenience are considered.

This application is based on Japanese Patent Application No. 2006-264754, the content of which is incorporated herein by reference.

2. Description of Related Art

A known method in the related art of managing acquired images from digital cameras involves, for example, creating and categorizing folders for each acquisition date and time (for instance, see Japanese Unexamined Patent Application, Publication No. 2001-282813).

Japanese Unexamined Patent Application, Publication No. 2001-282813 describes a system in which an acquired image is managed in association with information about the location where that image was acquired, as well as time information; and when both the location information and the time information are input as search keys, image data including this information is read out and displayed.

### BRIEF SUMMARY OF THE INVENTION

A first aspect of the present invention is an information management method including reading, at information creation time, identification information of a wireless IC tag built into personal belongings which an information creator carries and recording created information in association with the read identification information; and reading, at readout request time, identification information of a wireless IC tag built into personal belongings of a person requesting readout of information and allowing readout of the corresponding information when the read identification information matches identification information associated with information which is the subject of the readout request.

A second aspect of the present invention is a digital camera including an image-acquisition unit configured to acquire image information; an ID reading unit configured to read identification information of a wireless IC tag built into personal belongings that an image-acquiring person carries; a recording unit configured to associate and record the read identification information and image information; a display unit; and a control unit. At the time of a display request for the image information, the control unit displays the image information on the display unit when the identification information read by the ID reading unit matches the identification information associated with the image information which is the subject of the display request.

### BRIEF DESCRIPTION OF THE SEVERAL VIEWS OF THE DRAWINGS

FIG. 1 is a diagram showing, in outline, the configuration of a digital camera according to an embodiment of the present invention.

FIG. 2 is a flowchart for explaining an image recording process executed at image recording time.

FIG. 3 is a diagram showing an example of information stored in a storage unit.

FIG. 4 is a flowchart for explaining an image display process executed at image display request time.

FIG. 5 is a diagram showing, in outline, the configuration of a laptop computer according to an embodiment of the present invention.

### DETAILED DESCRIPTION OF THE INVENTION

An information management method of the present invention reads, at information creation time, identification information of a wireless IC tag built into personal belongings which an information creator carries and records created information in association with the read identification information; and reads, at readout request time, identification information of a wireless IC tag built into personal belongings of a person requesting readout of information and allows readout of the corresponding information when the read identification information matches identification information associated with information which is the subject of the readout request.

According to the method described above, at information creation time, identification information of the wireless IC tag built into the personal belongings that the information creator carries is read, and this identification information and created information are associated and recorded. In addition, when a readout request for information is issued, the identification information of the wireless IC tag built into the personal belongings of the person requesting readout is read, and readout of the corresponding information is allowed when this identification information matches the identification information of the information for which the readout request was issued.

Accordingly, because it is possible to automatically restrict persons who are permitted to readout information, when, for example, a plurality of users share one device, information created by one user can be read out by only that user, and the information can be prevented from being read out by other users. Therefore, it is possible to maintain security. Furthermore, at information creation time, because identification information related to the personal belongings of the owner is automatically associated with the created information and recorded, it is possible to classify and manage information for each type of identification information.

Examples of the information mentioned above include document data, image data, audio data, and so forth.

In the information management method described above, information may be recorded in association with a plurality of items of the identification information; and readout of the information may be allowed when any of the identification information associated with the information which is the subject of the readout request matches any of the identification information read out from the wireless IC tag.

According to the method described above, even if there are a plurality of personal belongings and the combination of those personal belongings differs from day to day, so long as one item of personal belongings identical to that when recording the information is carried, it is possible to readout the information. Thus, it is possible to increase the degree of freedom of information readout.

In the information management method described above information may be recorded in association with a plurality of items of the identification information; and readout of the information may be allowed when the identification information associated with the information which is the subject of the readout request and the identification information read out from the wireless IC tag completely match.

According to the method described above, unless the same personal belongings as the personal belongings carried when recording the information are carried, readout of information is not permitted, and therefore, high security can be ensured.

In the information management method described above, information may be recorded in association with a plurality of items of the identification information; and whether to allow readout of the information which is the subject of the readout request when all of the identification information matches or whether to allow readout of the information when any of the identification information matches can be selected, and readout of the information may be performed according to the allowed condition that is selected.

According to the method described above, when information is recorded in association with a plurality of items of identification information, the user can determined whether to allow readout of the information when any of the plurality of items of identification information matches or whether to allow readout of the information when the identification information completely matches. Thus, the user can set the appropriate condition, considering both the level of security and readout freedom.

In the information management method described above, when the identification information of the wireless IC tag built into the personal belongings is read, information which can be read out according to the read identification information may be identified, and a list of the identified information may be displayed.

Thus, when the identification information of the wireless IC tag built into the personal belongings is read, a list of information which can be read out according to this identification information is displayed. Therefore, the user can easily ascertain the information which can be read out by checking this list.

A digital camera of the present invention includes an image-acquisition unit configured to acquire image information; an ID reading unit configured to read identification information of a wireless IC tag built into personal belongings that an image-acquiring person carries; a recording unit configured to associate and record the read identification information and image information; a display unit; and a control unit, wherein, at the time of a display request for the image information, the control unit displays the image information on the display unit when the identification information read by the ID reading unit matches the identification information associated with the image information which is the subject of the display request.

According to the configuration described above, the image information acquired by the image-acquisition unit is associated with the identification information of the wireless IC tag built into the personal belongings which the image-acquirer carries, and it is then recorded. Also, at the time of a display request for the image in the recording unit, the identification information of the wireless IC tag built into the personal belongings of the user who issues the display request is read, and if this identification information matches the identification information associated with the image information which is the subject of the display request, the corresponding image information is displayed on the display unit. Accordingly, persons to whom the image can be displayed can be restricted to persons in the vicinity when it was acquired, and therefore, it is possible to ensure security. Furthermore, when recording the image information, because the identification information of the wireless IC tags built into the personal belongings of the users present at that location is automatically associated with the image information and recorded, it is possible to easily classify the image information.

In the digital camera described above, the recording unit may be capable of recording the image information in association with a plurality of items of the identification information; and the control unit may display the image information on the display unit when any of the identification information associated with the image information which is the subject of the display request matches any of the identification information read by the ID reading unit.

According to this configuration, even if there are a plurality of personal belongings and the combination of those personal belongings differs from day to day, it is possible to check the image information so long as one item of personal belongings that is the same as that when the image information was recorded is carried. Therefore, it is possible to increase the degree of freedom at display request time.

In the digital camera described above, the recording unit may be capable of recording the image information in association with a plurality of items of the identification information; and the control unit may display the image information on the display unit when the identification information associated with the image information which is the subject of the display request and the identification information read by the ID reading unit completely match.

According to this configuration, the corresponding image information is displayed only when the plurality of items of identification information associated with the image information completely match the identification information read by the ID reading unit at display request time. Therefore, it is possible to increase the level of security.

The digital camera described above may further include a selection unit, wherein the recording unit may be capable of recording the image information in association with a plurality of items of the identification information, the selection unit may be configured to select whether to display an image only when the identification information completely matches or whether to display the image when any of the identification information matches, in the event of the display request, and the control unit may display the image for which there is a display request on the display unit according to the selection condition selected by the selection unit.

According to this configuration, when the image information is recorded in association with the plurality of items of identification information, the user can determined whether to display the image information when any of the identification information matches or whether to display the image information when all of the identification information matches. Thus, the user can set the appropriate condition, considering both the level of security and the freedom of readout.

In the digital camera described above, at display request time, the control unit may identify, from the recording unit, image information which can be displayed on the basis of the identification information read by the ID reading unit, and may display a list of identified image information on the display unit.

In the event of a display request, the image information which can be displayed is identified according to the identification information read by the ID reading unit, and a list of identified image information is displayed on the display unit. Therefore, by checking this list, the user can easily ascertain the image information which can be displayed.

The aspects described above can be used in combination within the permissible scope of the invention.

The information management method and the digital camera described above afford the advantage in that it is possible to reduce the burden on the user, in terms of information management, while ensuring security.

An embodiment in which the information management method is employed in a digital camera will be described below with reference to the drawings.

### Digital Camera

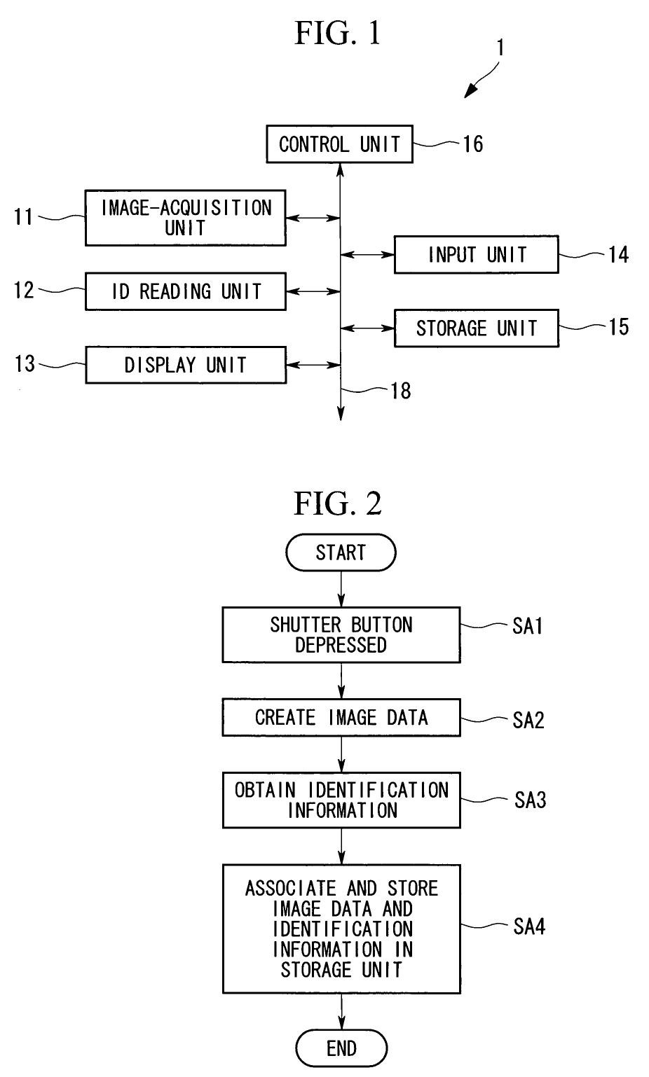

FIG. 1 is a block diagram showing, in outline, the configuration of a digital camera 1. As shown in FIG. 1, the digital camera 1 includes, as the main components thereof, an image-acquisition unit (image-acquisition device) 11, and ID reading unit (ID reading apparatus) 12, a display unit (display device) 13, an input unit 14, a storage unit (recording unit) 15, and a control unit (control apparatus) 16. These components are connected to each other via a bus 18 and are configured so that it is possible to send and receive information between them.

The image-acquisition unit 11 has a configuration for acquiring images of a subject and creating image data, and outputs the created image data to the control unit 16, which will be described later. For example, the image-acquisition unit 11 has a configuration which is substantially the same as the configuration of a known digital-camera image-acquisition unit, including an optical lens, a CCD camera, an image-processing circuit, and so forth.

The ID reading unit 12, which is, for example, an IC tag reader, reads identification information from the wireless IC tag built into the personal belongings that a person in the vicinity carries when acquiring an image, such as an image-acquirer, and outputs the read identification information to the control unit 16, which is described later.

The display unit 13 is, for example, a liquid crystal display.

The input unit 14 is a device for the user to input instructions, such as a button or dial, and functions as a man-machine interface.

The storage unit 15 stores image data and so forth acquired by the image-acquisition unit 11. Details of the information stored in the storage unit 15 will be given later.

The control unit 16 performs overall control of the individual components described above.

The operation of the digital camera 1 having such a configuration will be described next.

Personal belongings which the user carries are assumed to have built-in wireless IC tags that store identification information about the personal belongings. Examples of personal belongings include accessories such as rings, necklaces, and watches or clothes such as neckties, shirts, and trousers. The wireless IC tag should be built-in to at least one of these personal belongings.

### Image Recording Process

First, when a shutter release button provided in the input unit 14 of the digital camera 1 is pressed by the user (step SA1 in FIG. 2), the subject is acquired by the image-acquisition unit 11, and image data is created. The image data created by the image-acquisition unit 11 is output to the control unit 16 (step SA2).

Simultaneously with creation of the image data, the identification information is read from the wireless IC tag built into the personal belongings of the user by the ID reading unit 12, and the read identification information is output to the control unit 16 (step SA3). Here, because the wireless IC tags are built into a plurality of personal belongings that the user carries, when a plurality of items of identification information are read by the ID reading unit 12, all of the read identification information is output to the control unit 16.

When the image data and the identification information are input, the control unit 16 associates them and stores them in the storage unit 15 (step SA4).

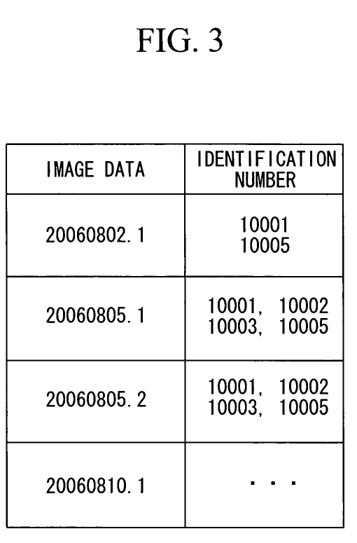

By performing the above image-recording process each time a picture is acquired, as shown in FIG. 3, a plurality of items of data, in which the image data and the identification information are associated, are accumulated in the storage unit 15.

### Image Display Process

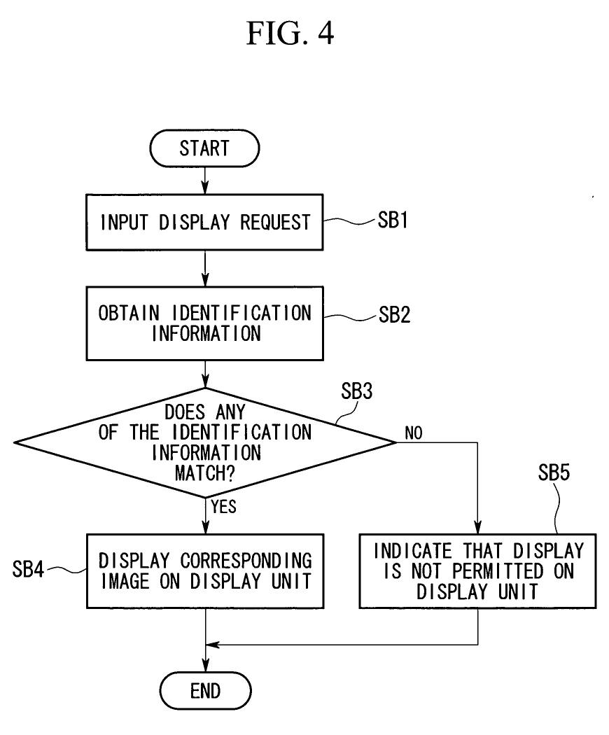

When a predetermined image is specified by the user by operating the input unit 14 and a display request for that image is issued, the display request is output from the input unit 14 to the control unit 16 (step SB1 in FIG. 4). Once the display request is input, the control unit 16 activates the ID reading unit 12.

Accordingly, the identification information is read from the wireless IC tag built into the user's personal belongings by the ID reading unit 12, and the read identification information is output to the control unit 16 (step SB2). When the identification information is input, the control unit 16 determines whether any of the identification information associated with the image data which is the subject of the display request, in the storage unit 15, matches the identification information read by the ID reading unit 12 (step SB3). If, as a result, any of the identification information matches, the image data for which the display request was issued is read out from the storage unit 15 and is displayed on the display unit 13 (step SB4). If, on the other hand, there is no matching identification information, the control unit 16 displays on the display unit 13 an indication to the effect that display is not permitted (step SB5).

According to the digital camera 1 described above, image information obtained by the image-acquisition unit 11 is associated with identification information of the wireless IC tag built into the personal belongings which the user carries and is stored in the storage unit 15. In addition, at image display request time, the identification information of the wireless IC tag built into the personal belongings of a user who issues a display request is read, and when this identification information matches the identification information associated with the image information which is the subject of the display request, the corresponding image information is displayed on the display unit 13.

Accordingly, persons to whom the image can be displayed can be restricted to persons in the vicinity when that image was acquired. Therefore, it is possible to increase the level of security. Furthermore, when registering the image information, the identification information of the wireless IC tag built into the personal belongings of a user in that location are automatically associated with the image information and stored in the storage unit 15. Therefore, the image information can be easily categorized.

When a plurality of items of identification information are associated with the image information, if any of them match, the image information is displayed on the display unit 14. Therefore, the degree of freedom at display request time can be increased.

During the above-described image acquisition, when the digital camera 1 is operated while a plurality of users are present, the identification information of wireless tags built into the respective personal belongings which the plurality of users carry is read by the ID reading unit 12, and the plurality of items of identification information is associated with the corresponding image data and stored in the storage unit 15. Also, when there is an image display request, when the digital camera 1 is operated while a plurality of users are present, if the identification information for the personal belongings of any user matches the identification information associated with the image data which is the subject of the display request, that image data is displayed on the display unit 13.

With the digital camera 1 described above, the following applications are envisaged.

For example, when taking a picture at a travel destination when traveling together with a friend, identification information of a wireless IC tag built-into the friend's personal belongings and identification information of a wireless IC tag built into one's own personal belongings are associated with the image data created by the image-acquisition unit 11 and are stored in the storage unit 15. Accordingly, it is possible to associate the image data of the travel destination with the personal belongings carried while traveling.

Then, after returning home from the trip, by operating the camera 1 while wearing the personal belongings carried while traveling, it is possible to view images of the travel destination while more clearly recalling the conditions at the destination.

In this embodiment, when a display request for an image is input by the user, the corresponding image data is displayed on the display unit 13 if any of the identification information read by the ID reading unit matches any of the identification information associated with the image data requested tQ be displayed. Instead of this, however, the corresponding image may be displayed on the display unit 13 only if both types of identification information completely match. By displaying the image only if the identification information completely matches in this way, it is possible to increase the level of security.

The digital camera 1 according to this embodiment may further include a selection unit (selection device; not shown in the drawings) for the user to select whether to allow display even when just one of the items of associated identification information, at the time of recording the image information, matches (hereinafter referred to as “partial match condition”), or whether to allow display when the associated identification information completely matches (hereinafter referred to as “complete match condition”), when performing readout of the corresponding image information.

By providing such a selection unit, the user can set the appropriate condition, considering both the level of security and the degree of freedom of readout. As a result, when the image information is highly confidential, by setting the complete match condition, it is possible to prevent the image information from being displayed unless the identification information associated with the corresponding image information and the identification information read by the ID reading unit 12 at display request time completely match.

When the image information is not highly confidential, by setting the partial match condition, it is possible to display the image information if any of the identification information matches.

When a display request is input by the user, the identification information may be read from the wireless IC tag built into the personal belongings of the user by operating the ID reading unit 12, all of the image information associated with this read identification information may be extracted, and a list of extracted image information may be displayed on the display unit 13.

By displaying on the display unit 13 the list of image information associated with the corresponding identification information in this way, the user can easily ascertain the image information which can be displayed.

### Laptop Computer

Next, an embodiment in the case where the information management method is employed in a laptop computer (hereinafter referred to as “computer”) will be described.

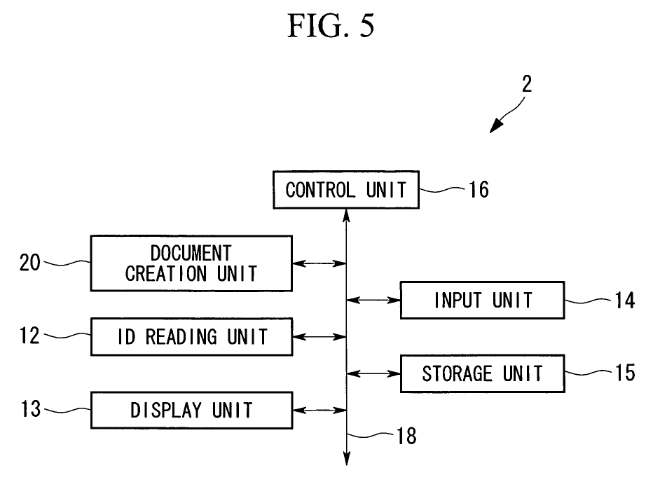

FIG. 5 shows, in outline, the configuration of the computer.

As shown in FIG. 5, instead of the image-acquisition unit 11 shown in FIG. 1, the computer 2 is provided with a document-creating unit 20. Other elements are the same as the elements shown in FIG. 1.

In this computer 2, when a document is created by the document-creating unit 20 due to the user operating the input unit 14, the document data is output to the control unit 16. Similarly, identification information of a wireless tag built into the user's personal belongings is read by the ID reading unit 12, and this identification information is output to the control unit 16. The control unit 16 associates the identification information and the corresponding document data and stores them in the storage unit 15.

When there is a readout request for the document data, the control unit 16 activates the ID reading unit 12 and obtains the identification information of the wireless IC tag built into the personal belongings of the user who issued the readout request. Then, the control unit 16 determines whether or not there is a match between the obtained identification information and the identification information associated with the document data which is the subject of the readout request, and if there is a match, readout of the corresponding document data is permitted. Thereafter, the document data is displayed on the display unit. On the other hand, if there is no match, it is determined that it is a readout request from another person who does not have authorization to readout the corresponding document, and readout of the corresponding document data is denied.

With this computer 2, the following applications are envisaged.

For example, when a document is created at the workplace using the computer 2, the document data is associated with identification information of a wireless IC tag built into a suit or accessories which one frequently wears at the workplace, an identification card which one carries in the workplace, or the like, and they are stored in the storage unit 15.

On the other hand, when a document is created at home using the computer 2, the document data is associated with identification information built into personal belongings frequently carried at home, and they are stored in the storage unit 15.

Thus, by storing the respective document data in the storage unit 15 in association with the different identification information at the workplace and at home, for example, it is possible to automatically classify the document data to be used in the workplace and at home. In addition, when using the computer 2 in the workplace, by setting a mode where it is not possible to read out document data and the like which is created at home, it is possible to avoid a situation document data created at home can be seen by persons in the company. Thus, when the information management method of the present invention is applied to the computer 2, similarly to the digital camera 1 described above, it is possible to ensure a sufficient level of security, and in addition, to classify document data without burdening the user.

Embodiments of the information management method and the digital camera have been described above with reference to the drawings. However, the specific configurations are not limited to these embodiments; various modifications are also included, so long as they do not depart from the spirit of the invention.

What is claimed is:

1. An information management method comprising:
reading, at information creation time, identification information of a wireless IC tag built into personal belongings which an information creator carries and recording created information in association with the read identification information; and
reading, at readout request time, identification information of a wireless IC tag built into personal belongings of a person requesting readout of the information and
allowing readout of the corresponding information when the read identification information matches the identification information associated with information which is the subject of the readout request.

2. An information management method according to claim 1, wherein:
the information is recorded in association with a plurality of items of the identification information; and
readout of the information is allowed when any of the identification information associated with the information which is the subject of the readout request matches any of the identification information read out from the wireless IC tag.

3. An information management method according to claim 1, wherein:
the information is recorded in association with a plurality of items of the identification information; and
readout of the information is allowed when the identification information associated with the information which is the subject of the readout request and the identification information read out from the wireless IC tag completely match.

4. An information management method according to claim 1, wherein:
the information is recorded in association with a plurality of items of the identification information; and
whether to allow readout of the information which is the subject of the readout request when all of the identification information matches or whether to allow readout of the information when any of the identification information matches can be selected, and readout of the information is performed according to the allowed condition that is selected.

5. An information management method according to claim 1, wherein when the identification information of the wireless IC tag built into the personal belongings is read, information which can be read out according to the read identification information is identified, and a list of the identified information is displayed.

6. A digital camera comprising:
an image-acquisition unit configured to acquire image information;
an ID reading unit configured to read identification information of a wireless IC tag built into personal belongings that an image-acquirer carries;
a recording unit configured to associate and record the read identification information and image information;
a display unit; and
a control unit,
wherein, at the time of a display request for the image information, the control unit displays the image information on the display unit when the identification information read by the ID reading unit matches the identification information associated with the image information which is the subject of the display request.

7. A digital camera according to claim 6, wherein:
the recording unit is capable of recording the image information in association with a plurality of items of the identification information; and
the control unit displays the image information on the display unit when any of the identification information associated with the image information which is the subject of the display request matches any of the identification information read by the ID reading unit.

8. A digital camera according to claim 6, wherein:
the recording unit is capable of recording the image information in association with a plurality of items of the identification information; and
the control unit displays the image information on the display unit when the identification information associated with the image information which is the subject of the display request and the identification information read by the ID reading unit completely match.

9. A digital camera according to claim 6, further comprising:
a selection unit;
wherein the recording unit is capable of recording the image information in association with a plurality of items of the identification information,
the selection unit is configured to select whether to display an image only when the identification information completely matches or whether to display the image when any of the identification information matches, in the event of the display request, and
the control unit displays the image for which there is a display request on the display unit according to the selection condition selected by the selection unit.

10. A digital camera according to claim 6, wherein, at display request time, the control unit identifies, from the recording unit, image information which can be displayed on the basis of the identification information read by the ID reading unit, and displays a list of the identified image information on the display unit.
